(19) United States
(12) Patent Application Publication
(10) Pub. No.: US 2022/0391467 A1
(43) Pub. Date: Dec. 8, 2022

(54) VARIABLE OPTIMIZATION APPARATUS, VARIABLE OPTIMIZATION METHOD, AND PROGRAM

(71) Applicant: NIPPON TELEGRAPH AND TELEPHONE CORPORATION, Tokyo (JP)

(72) Inventor: Kenta NIWA, Tokyo (JP)

(73) Assignee: NIPPON TELEGRAPH AND TELEPHONE CORPORATION, Tokyo (JP)

(21) Appl. No.: 17/761,592

(22) PCT Filed: Sep. 19, 2019
(86) PCT No.: PCT/JP2019/036692

§ 371 Date: Mar. 17, 2022

(51) Int. Cl. G06F 17/13; G06T 5/00

(52) U.S. Cl. CPC G06F 17/13; G06T 5/002

(57) ABSTRACT

Provided is a technology that optimizes a variable being an optimization target at high speed. A variable optimization apparatus includes a variable update unit configured to, by assuming that w is a variable being an optimization target. G(w)(=G1(w)+G2(w)) is a cost function for optimizing the variable w, calculated by using input data. D is a strictly convex function that is differentiable and satisfies ∇D(0)=0. Ri and Ci are a D-resolvent operator and a D-Cayley operator, respectively and −Gi(w) is a strongly convex function approximating a function Gi(w), recursively calculate a value of the variable w by using the D-resolvent operator Ri and the D-Cayley operator Ci. When the variable update unit calculates ∇D(w), for a D-resolvent operator R1 and a D-Cayley operator C1, T1(w)=∇−G1(w)−∇−G1(0) is used for calculation of ∇D(w), and for a D-resolvent operator R2 and a D-Cayley operator C2, ∇T2(w)=∇−G2(w)−∇−G2(0) is used for calculation of ∇D(w).

### TECHNICAL FIELD

The present invention relates to a technology of optimizing variables.

### BACKGROUND ART

An optimization technology is used in various fields, such as image processing, speech recognition, and natural language processing. In the optimization technology, for the sake of optimization, cost functions designed depending on individual problems are used.

The following considers a minimization problem of a cost function G(w)=G₁(w)+G₂(w)(w ∈Rⁿ (n is an integer of 1 or greater) is a variable being a optimization target, and functions G₁ and G₂: Rⁿ→R∪{∞} are each a closed proper convex function (the closed proper convex function is hereinafter simply referred to as a convex function)).

$$[ Math . 1 ]$$

$${inf}_{w} {G}_{1} ( w ) + {G}_{2} ( w ) \qquad ( 1 )$$

Note that, even when the cost function G includes three or more terms, if those are expressed as a sum of two convex functions, those are reduced to expression (1).

A fixed point w, which is an optimal solution (that is, a value that is ultimately obtained through optimization) of the minimization problem (also referred to as a convex optimization problem) is obtained when a subdifferential of the cost function G includes 0.

[Math. 2]

0∈∂G₁(w)+∂G₂(w) (2)

Here, ∂ represents a subdifferential operator. Further, ∂Gᵢ(i=1, 2) is a maximum monotone operator.

Note that, if the function Gᵢ includes non-continuous points, their subdifferentials form a set. Accordingly, the subdifferentials (right-hand side) of expression (2) may have multiple values. Thus, here, the symbol of inclusion “∈” is used instead of the equal sign “=”.

Lagrange Dual Ascent Problem

As shown in the following expression, the following considers a problem (Lagrange dual ascent problem) of minimizing the sum of two convex cost functions H₁: R^{k}→R∪{∞} and H₂: R^{m}→R∪{∞} when two variables {p, q}(p ∈ R^{k} and q ∈ R^{m} (k and m are each an integer of 1 or greater)) are restrained by a linear expression.

$$[ Math . 3 ]$$

$${inf}_{p , q} {H}_{1} ( p ) + {H}_{2} ( q ) s . t . Ap + Bq = c \qquad ( 3 )$$

Here, matrices A ∈ R^{n×k} and B ∈ R^{n×m} and a vector c ∈ Rⁿ (n is an integer of 1 or greater) are given in advance.

One useful strategy for solving a linear restrained minimization problem such as the Lagrange dual ascent problem is to solve a dual problem. If there is a dual problem for the linear restrained minimization problem, the dual problem is defined as a sup/inf (maximum/minimum) problem of a Lagrange function L (p, q, λ).

$$[ Math . 4 ]$$

$${sup}_{λ} {inf}_{p , q} L ( p , q , λ ) = - {inf}_{λ} {H}_{1}^{*} ( {A}^{T} λ ) + {H}_{2}^{*} ( {B}^{T} λ ) - 〈 λ , c 〉 \qquad ( 4 )$$

Here, λ ∈ Rⁿ is a dual variable, and ·^{T} represents transpose. Further, Hᵢ*(i=1, 2) is a convex conjugation function of Hᵢ, and is given by the following respective expressions.

$$[ Math . 5 ]$$

$${H}_{1}^{*} ( {A}^{T} λ ) = {sup}_{p} ( 〈 λ , Ap 〉 - {H}_{1} ( p ) ) \\ {H}_{2}^{*} ( {B}^{T} λ ) = {sup}_{q} ( 〈 λ , Bq 〉 - {H}_{2} ( q ) )$$

It can be understood that, if λ and w are replaced with each other to obtain ∂G₁(w)=A∂H₁*(A^{T}w) and ∂G₂(w)=B∂H₂*(B^{T}w)−c, the problem on the right-hand side of expression (4) arrives at the problem for obtaining the fixed point of expression (2).

As a specific example of the Lagrange dual ascent problem, there is a noise elimination problem of an image using a total variation norm. This problem will be described later.

As one method of solving a minimization problem of a cost function such as a Lagrange dual ascent problem, there is a method described in NPL 1.

### CITATION LIST

### Non Patent Literature

NPL 1: K. Niwa and W. B. Kleijn, “Bregman monotone operator splitting”, https://arxiv.org/abs/1807.04871, 2018.

### SUMMARY OF THE INVENTION

### Technical Problem

When a Lagrange dual ascent problem is solved by using a variable update rule described in NPL 1, in some cases, it is not easy to update (or it is not possible to update) a variable in one step so that a value of a cost function is reduced. In other words, in some cases, the conventional variable update rule has a problem in that convergence to an optimal solution takes time, that is, a problem in that optimization of a variable takes time.

In the light of this, the present invention has an object to provide a technology that optimizes a variable being an optimization target at high speed.

### Means for Solving the Problem

In one aspect of the present invention, assuming that w ∈ Rn is a variable being an optimization target, and G(w)(=G₁(w)+G₂(w)) is a cost function for optimizing the variable w, calculated by using input data (note that a function Gᵢ(w): Rⁿ→R∪{∞} (i=1, 2) is a closed proper convex function), and D: Rⁿ→R is a strictly convex function (note that the function D is differentiable, and satisfies ∇D(0)=0), and Rᵢ(i=1, 2) and Cᵢ(i=1, 2) are a D-resolvent operator and a D-Cayley operator defined by following expressions, respectively,

Rᵢ=(I+(∇D)⁻¹∘∂Gᵢ)⁻¹

Cᵢ=(I+(∇D)⁻¹∘∂Gᵢ)⁻¹∘(I−(∇D)⁻¹∘∂Gᵢ) [Math. 6]

a variable optimization apparatus recursively calculates a value of the variable w by using the D-resolvent operator Rᵢ(i=1, 2) and the D-Cayley operator Cᵢ(i=1, 2). ⁻Gᵢ(w) (i=1, 2) is a strongly convex function approximating the function Gᵢ(w)(i=1, 2). In the recursively calculating of the value, when ∇D(w) is calculated, for a D-resolvent operator R₁ and a D-Cayley operator C₁, T₁(w)=∇⁻G₁(w)−∇⁻G₁(0) is used for calculation of ∇D(w), and for a D-resolvent operator R₂ and a D-Cayley operator C₂, T₂(w)=∇⁻G₂(w)−∇⁻G₂(0) is used for calculation of ∇D(w).

### Advantageous Effects of Invention

According to the present invention, a variable being an optimization target can be optimized at high speed.

### BRIEF DESCRIPTION OF DRAWINGS

FIG. 1 is a diagram illustrating variable update algorithm for a convex optimization problem.

FIG. 2 is a diagram illustrating variable update algorithm for a convex optimization problem.

FIG. 3 is a diagram illustrating variable update algorithm for a Lagrange dual ascent problem.

FIG. 4 is a diagram illustrating variable update algorithm for a Lagrange dual ascent problem.

FIG. 5 is a diagram illustrating variable update algorithm for a noise elimination problem.

FIG. 6 is a block diagram illustrating a configuration of a variable optimization apparatus 100/200.

FIG. 7 is a flowchart illustrating operation of the variable optimization apparatus 100/200.

FIG. 8 is a block diagram illustrating a configuration of a variable update unit 120.

FIG. 9 is a flowchart illustrating operation of the variable update unit 120.

FIG. 10 is a block diagram illustrating a configuration of a variable update unit 220.

FIG. 11 is a flowchart illustrating operation of the variable update unit 220.

FIG. 12 is a block diagram illustrating a configuration of a noise elimination apparatus 300.

FIG. 13 is a flowchart illustrating operation of the noise elimination apparatus 300.

FIG. 14 is a block diagram illustrating a configuration of an image update unit 320.

FIG. 15 is a flowchart illustrating operation of the image update unit 320.

FIG. 16 is a diagram illustrating an example of a functional configuration of a computer implementing each apparatus according to an embodiment of the present invention.

### DESCRIPTION OF EMBODIMENTS

Hereinafter, embodiments of the present invention will be described in detail. Components having the same function are denoted by the same reference signs, and redundant description thereof will be omitted.

Prior to describing each embodiment, the method of notation herein will be described.

_(underscore) represents the subscript. For example, x^{y_z} represents y_{z} is the superscript to x, and x_{y_z} represents y_{z} is the subscript to x.

A superscript “\hat{ }” or “˜”, such as ^{\hat{ }}x or ^{˜}x to a character x, should be described otherwise above “x”, but are described as ^{\hat{ }}x or ^{˜}x, under the limitations of the written description herein.

### TECHNICAL BACKGROUND

First, a procedure for solving the problem of expression (2) will be described in detail with reference to NPL 1.

1: Variable Update Rule Based on Bregman Monotone Operator Splitting

Here, as a method for solving the problem of expression (2), a method using Bregman monotone operator splitting will be described. The method is a variable update rule for obtaining such a fixed point that ultimately minimizes a cost function G while updating in parallel a plurality of variables including a variable w. Note that a variable being a target of optimization may be referred to as a primary variable.

First, prior to deriving a variable update rule, some preparations are performed.

1-1: Bregman Divergence

Bregman divergence has a role important for correcting measurement of a variable space. For two different points {w, z}, Bregman divergence J_{D}(w∥z) is defined by the following expression.

[Math. 7]

J_{D}(w∥z)=D(w)−D(z)− [symbol] ∇D(z),w−z [symbol] (5)

Here, ∇ represents a differential operator. As a function D: Rⁿ→R used for definition of Bregman divergence, any differentiable strictly convex function can be used. Thus, the function D may be, for example, an asymmetric function.

In the following description, the function D is limited to a function that satisfies ∇D(0)=0. The reason for the limitation is to let the following expression (6) hold, in which ∇D is applied to expression (2) being a condition related to the fixed point.

[Math. 8]

0∈(∇D)⁻¹∘∂G₁(w)+(∇D)⁻¹∘∂G₂(w) (6)

Here, ⁻¹ represents an inverse operator, and o represents a synthesis of two operators.

In general, with different functions D, property of (∇D)⁻¹∘∂Gᵢ varies. Thus, depending on design of ∇D, the convergence rate of the variable update rule varies. In other words, ∇D significantly affects increasing the speed of the convergence rate. The design of ∇D that can increase the speed of the convergence rate will be described later.

1-2: D-Resolvent Operator and D-Cayley Operator

A D-resolvent operator Rᵢ(i=1, 2) and a D-Cayley operator Cᵢ(i=1, 2) are given in expression (7) and expression (8), respectively.

$$[ Math . 9 ]$$

$${R}_{i} = {( I + {( ▽ D )}^{- 1} ∘ \partial {G}_{i} )}^{- 1} \qquad ( 7 )$$

$$\begin{matrix}{C}_{i} = {( I + {( ▽ D )}^{- 1} ∘ \partial {G}_{i} )}^{- 1} ∘ ( I - {( ▽ D )}^{- 1} ∘ \partial {G}_{i} ) \\ = 2 {( I + {( ▽ D )}^{- 1} ∘ \partial {G}_{i} )}^{- 1} - {( I + {( ▽ D )}^{- 1} ∘ \partial {G}_{i} )}^{- 1} ∘ ( I + {( ▽ D )}^{- 1} ∘ \partial {G}_{i} ) \\ = 2 {( I + {( ▽ D )}^{- 1} ∘ \partial {G}_{i} )}^{- 1} - I \\ = 2 {R}_{i} - I\end{matrix} \qquad ( 8 )$$

Here, I represents the same operator.

Note that, if an n-dimensional Euclidean distance function is used as the function D, the D-resolvent operator and the D-Cayley operator are respectively a resolvent operator and a Cayley operator being widely known. In other words, the D-resolvent operator and the D-Cayley operator are respectively an operator that is obtained by generalizing the resolvent operator and an operator that is obtained by generalizing the Cayley operator.

1-3: Variable Update Rule based on Bregman Monotone Operator Splitting

On the basis of the preparations described above, the variable update rule based on Bregman monotone operator splitting is derived. Here, a Bregman Peaceman-Rachford (B-P-R) variable update rule based on Bregman Peaceman-Rachford (B-P-R) monotone operator splitting (B-P-R splitting) and a Bregman Douglas-Rachford (B-D-R) variable update rule based on Bregman Douglas-Rachford (B-D-R) monotone operator splitting (B-D-R splitting) will be described.

The B-P-R variable update rule can be obtained by transforming expression (6), which represents a condition related to the fixed point in which measurement of the variable space is corrected by (∇D)⁻¹.

With the use of an auxiliary variable z of the variable w that satisfies w ∈ R₁(z), expression (9) of B-P-R monotone operator splitting recursive with respect to the auxiliary variable z can be obtained.

[Math.10]

0∈(I+(∇D)⁻¹∘∂G₂)(w)−(I−(∇D)⁻¹∘∂G₁)(w)

0∈(I+(∇D)⁻¹∘∂G₂)∘R₁(z)−(I−(∇D)⁻¹∘∂G₁)∘R₁(z)

0∈R₁(z)−R₂∘C₁(z)

0∈½(C₁+I)(Z)−½(C₂+I)∘C₁(z)

z∈C₂∘C₁(z) (9)

In the B-P-R variable update rule using expression (9), the fixed point can be obtained by repeatedly updating the variable by using D-Cayley operators C₁ and C₂.

By splitting expression (9) into a simple variable update rule (B-P-R variable update rule) with the use of the D-resolvent operators R₁ and R₂ and the auxiliary variables x, y, and z ∈ Rⁿ, expression (10) to expression (13) can be obtained.

[Math.11]

w^{t+1}=R₁(z^{t})=(I+(∇D)⁻¹∘∂G₁)⁻¹(z^{t}) (10)

x^{t+1}=C₁(z^{t})=(2R₁−I)(z^{t})=2w^{t+1}−z^{t} (11)

y^{t+1}=R₂(x^{t+1})=(I+(∇D)⁻¹∘∂G₂)⁻¹(x^{t+1}) (12)

z^{t+1}=C₂(x^{t+1})=(2R₂−I)(x^{t+1})=2y^{t+1}−x^{t+1} (13)

Here, t is an index that represents the number of times of update.

Through transformation of expression (10), expression (14) is obtained.

[Math. 12]

(I+(∇D)⁻¹∘∂G₁)(w)∈z

0∈(∇D)⁻¹∘∂G₁(w)+w−z

0∈∂G₁(w)+∇D(w)−∇D(z) (14)

If there is a minimum value of the variable w, the integral form of expression (14) is represented by expression (15).

$$[ Math . 13 ]$$

$${w}^{i + 1} = arg {min}_{w} ( {G}_{1} ( w ) + {J}_{D} ( w ∥ {z}^{t} ) ) \qquad ( 15 )$$

Expression (15) above shows that a penalty term is generalized by using Bregman divergence.

Through a similar logic, the following expression is obtained based on expression (12).

$$[ Math . 14 ]$$

$${y}^{t + 1} = arg {min}_{y} ( {G}_{2} ( y ) + {J}_{D} ( y ∥ {x}^{t + 1} ) ) \qquad {( 15 )}^{′}$$

In summary, the B-P-R variable update rule based on B-P-R monotone operator splitting is as follows.

$$[ Math . 15 ]$$

$${w}^{t + 1} = arg {min}_{w} ( {G}_{1} ( w ) + {J}_{D} ( w ∥ {z}^{t} ) ) \\ {x}^{t + 1} = 2 {w}^{t + 1} - {z}^{t} \\ {y}^{t + 1} = arg {min}_{y} ( {G}_{2} ( y ) + {J}_{D} ( y ∥ {x}^{t + 1} ) ) \\ {z}^{t + 1} = 2 {y}^{t + 1} - {x}^{t + 1}$$

Next, the B-D-R variable update rule will be described. B-D-R monotone operator splitting can be obtained as expression (16), in which an averaging operator is applied to expression (9).

[Math. 16]

z∈αC₂∘C₁(z)+(1−α)z (16)

Here, α ∈ (0, 1).

Through a logic similar to the logic described above, the following B-D-R variable update rule based on B-D-R monotone operator splitting can be obtained.

$$[ Math . 17 ]$$

$${w}^{t + 1} = arg {min}_{w} ( {G}_{1} ( w ) + {J}_{D} ( w ∥ {z}^{t} ) ) \\ {x}^{t + 1} = 2 {w}^{t + 1} - {z}^{t} \\ {y}^{t + 1} = arg {min}_{y} ( {G}_{2} ( y ) + {J}_{D} ( y ∥ {x}^{t + 1} ) ) \\ {z}^{t + 1} = ( 1 - a ) {z}^{t} + a ( 2 {y}^{t + 1} - {x}^{t + 1} )$$

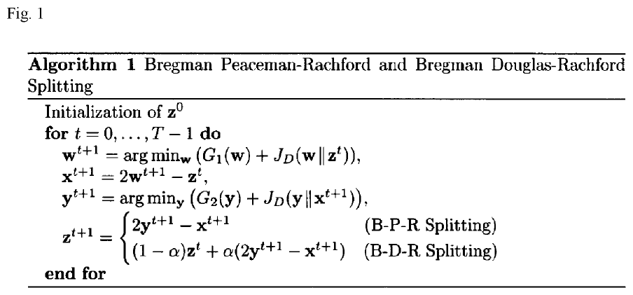

As has been described above, each of the B-P-R variable update rule and the B-D-R variable update rule is summarized as algorithm as illustrated in FIG. 1. FIG. 1 illustrates that the B-P-R variable update algorithm and the B-D-R variable update algorithm are implemented as update rules of the variable w and its auxiliary variables x, y, and z.

2: Condition for Increasing Speed of Convergence Rate

A condition for increasing the speed of the convergence rate is derived by calculating the convergence rate of B-P-R monotone operator splitting and B-D-R monotone operator splitting. With this, a design condition of ∇D for implementing the speed increase can be studied.

It is assumed that monotonicity of a subdifferential ∂Gᵢ is represented by expression (17), with the use of two different points {w, z}.

[Math. 18]

ρ_{LB,i}∥w−z∥₂≤∥∂Gᵢ(w)−∂Gᵢ(z)∥₂≤≤ρ_{UB,i}∥w−z∥₂ (17)

Here, {ρ_{LB,i}, ρ_{UB,i}} ∈ [0, ∞]. In general, {ρ_{LB,i}, ρ_{UB,i}} varies depending on a function Gᵢ. For example, if the function Gᵢ is strongly convex and Lipschitz smooth, {ρ_{LB,i}, ρ_{UB,i}} ∈ (0, ∞).

It is assumed that, by applying a measurement correction operator (∇D)⁻¹, monotonicity of expression (17) is represented by expression (18).

[Math. 19]

σ_{LB,i}∥w−z∥₂≤∥(∇D)⁻¹∘∂Gᵢ(w)−(∇D)⁻¹∘∂Gᵢ(z)∥₂≤σ_{UB,i}∥w−z∥₂ (18)

Here, {σ_{LB,i}, σ_{UB,i}} ∈ [0, ∞]. In general, {σ_{LB,i}, σ_{UB,i}} varies depending on design of ∇D.

Based on the assumption described above, the convergence rate of B-P-R monotone operator splitting of expression (9) is represented by expression (19) (description of detailed derivation thereof is herein omitted).

[Math. 20]

∥z^{t}−z^{*}∥₂≤(η₁η₂)^{t}∥z⁰−z^{*}∥₂ (19)

Here, z^{t} represents a value of z being updated t times, z⁰ represents an initial value of z, and z^{*} represents a fixed point of z. Further, ηᵢ (i=1, 2) is given by expression (20).

$$[ Math . 21 ]$$

$${η}_{i} = \sqrt{1 - \frac{4 {σ}_{LB , i}}{{( 1 + {σ}_{UB , i} )}^{2}}} \qquad ( 20 )$$

As can be understood from expression (20), the speed increase of the convergence rate can be further highly anticipated as ηᵢ has a value closer to 0.

This also applies to B-D-R monotone operator splitting, and the convergence rate of B-D-R monotone operator splitting of expression (16) is represented by expression (19)′.

[Math. 22]

∥z^{t}−z^{*}∥₂≤(1−α+αη₁αη₂)^{t}∥z⁰−z^{*}∥ (19)′

ηᵢ given by expression (20) satisfies expression (21). In other words, ηᵢ may have a value of 0 or greater and 1 or less.

$$[ Math . 23 ]$$

$$0 \leq \sqrt{1 - \frac{4 {σ}_{UB , i}}{{( 1 + {σ}_{UB , i} )}^{2}}} \leq {η}_{i} \leq 1 \qquad ( 21 )$$

As can be understood from the fact that ηᵢ=0 if σ_{LB,i}=1 and σ_{UB,i}=1, ηᵢ also has a value close to 0 if each of σ_{LB,i} and σ_{UB,i} has a value close to 1. Accordingly, by arranging ∇D in such a manner that each of σ_{LB,i} and σ_{UB,i} satisfying expression (18) has a value close to 1, the speed increase of the convergence rate can be expected.

3: Conventional Design of ∇D

In NPL 1, ∇D is designed as a linear function using a positive definite matrix M as shown in expression (22).

[Math. 24]

∇D(w)=Mw (22)

The reason why a linear function using the positive definite matrix M is used is because it is possible to combine with an existing optimization method, such as Newton's method, an accelerated gradient (AGD) method, and a (one-dimensional) gradient descent (GD) method, depending on the matrix M. In actuality, it has been demonstrated through numerical simulation that appropriate design of the positive definite matrix M enables implementation of high-speed convergence.

However, there are two requirements for the function D used for definition of Bregman divergence: (1) satisfaction of ∇D(0)=0, and (2) differentiable strictly convex function. In other words, design of ∇D with a linear function using the positive definite matrix M as in expression (22) is merely an example of the function D that satisfies the above-described two requirements. In other words, in addition to the design described above, there may be other functions D satisfying the above-described two requirements with which ∇D further increases the speed of the convergence rate.

4: Design of VD in Invention of Present Application

In view of this, the following proposes design of ∇D in which each of σ_{LB,i} and σ_{UB,i} satisfying expression (18) has a value close to 1, instead of limiting to the function D that satisfies ∇D(w)=Mw. Specifically, the following proposes a method (hereinafter referred to as an adaptive alternate measurement correction method) of (1) using a continuous non-linear function including high-order gradient information for ∇D, and (2) adapting it to ∂G₁ and ∂G₂ so as to alternately correct ∇D.

Thus, the use of ∇D that satisfies strong monotonicity is considered. Specifically, with the use of a differentiable strongly convex function ⁻Gᵢ (i=1, 2) that approximates the cost function Gᵢ, ∇D is defined by expression (23).

$$[ Math . 25 ]$$

$$▽ D ( w ) = \{ \begin{matrix}{γ}_{1}^{t} {T}_{1} ( w ) = {γ}_{1}^{t} ( ▽ {\overline{G}}_{1} ( w ) - ▽ {\overline{G}}_{1} ( 0 ) ) & ( for {R}_{1} and {C}_{1} ) \\ {γ}_{2}^{t} {T}_{2} ( w ) = {γ}_{2}^{t} ( ▽ {\overline{G}}_{2} ( w ) - ▽ {\overline{G}}_{2} ( 0 ) ) & ( for {R}_{2} and {C}_{2} )\end{matrix} \qquad ( 23 )$$

Here, positive coefficients {γ1^{t}, γ2^{t}} are used so that ∇D of expression (23) satisfies strong monotonicity. It is only required that, for example, {γ1^{t}, γ2^{t}} be the following expressions.

γ₁^{t}=∥γ₂^{t-1}T₂∘(∂G₁+∂G₂)(z^{t-1})∥₂/∥T₁∘(∂G₁+∂G₂)(z^{t-1})∥₂

γ₂^{t}=∥γ₁^{t}T₁∘(∂G₁+∂G₂)(x^{t})∥₂/∥T₂∘(∂G₁+∂G₂)(x^{t})∥₂ [Math.26]

From expression (23), it can be understood that ∇D is alternately adaptively corrected.

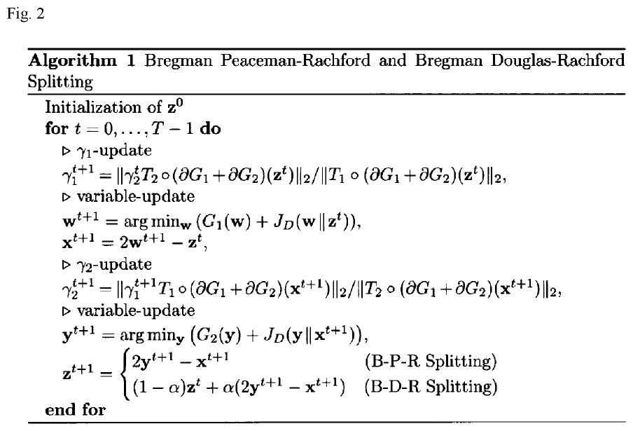

By adopting the design of ∇D of expression (23) into the B-P-R variable update algorithm and the B-D-R variable update algorithm of FIG. 1, the B-P-R variable update algorithm and the B-D-R variable update algorithm illustrated in FIG. 2 are obtained.

5: Variable Update Rule based on Bregman Monotone Operator Splitting for Lagrange Dual Ascent Problem

Here, with the use of ∇D of expression (23), the B-P-R variable update rule and the B-D-R variable update rule for the Lagrange dual ascent problem are derived.

As described in the above, in the Lagrange dual ascent problem, two maximum monotone operators ∂G₁(w)=A∂H₁*(A^{T}w) and ∂G₂(w)=B∂H₂*(B^{T}w)−c are used. By transforming the definitional expression w ∈ R₁(z) of the auxiliary variable z of the variable w by using ∂G₁(w)=A∂H₁*(A^{T}w) and expression (7) for the first maximum monotone operator ∂G₁(w), expression (24) is obtained.

[Math. 27]

w∈(I+(∇D)⁻¹∘A∂H₁^{*}(A^{T}))⁻¹(z)

w+(∇D)⁻¹∘A∂H₁^{*}(A^{T}w)∈z

∇D(w)∈∇D(z)−A∂H₁^{*}(A^{T}w) (24)

Here, expression (25) holds for variable p ∈ ∂H₁*(A^{T}w) and ˜w=∇D(w), ˜z=∇D(z) (that is, ˜w and ˜z are dual variables obtained by applying non-linear transformation to w and z, respectively).

[Math. 28]

\tilde{w}∈\tilde{z}−Ap (25)

With the use of the basic property that the subdifferential of the convex conjugation function satisfies ∂H₁*=(∂H₁)⁻¹, expression p ∈ ∂H₁*(A^{T}w) related to the variable p is transformed into expression (26).

[Math. 29]

p∈∂H₁^{*}(A^{T}w)

∂H₁(p)∈A^{T}w

0∈∂H₁(p)−A^{T}(∇D)⁻¹(\tilde{z}−Ap) (26)

Here, if there is a minimum value of p, the update rule of p is represented by expression (27) being an integral form of expression (26).

$$[ Math . 30 ]$$

$${p}^{t + 1} = arg {min}_{p} ( {H}_{1} ( p ) + {J}_{{D}^{+}} ( Ap ∥ {\tilde{z}}^{t} ) ) \qquad ( 27 )$$

Here, D⁺ is a strongly convex function that satisfies ∇D⁺=(∇D)⁻¹.

By combining expression (25) and expression ˜x ∈ 2˜w−˜z obtained by applying non-linear transformation to expression x ∈ 2w−z corresponding to expression (11), expression (28) representing an update rule of a dual variable ˜x is obtained.

[Math. 31]

\tilde{x}^{t+1}=\tilde{z}^{t}−2Ap^{t+1} (28)

Through a similar logic, the following expression can be derived for the second maximum monotone operator ∂G₂(w)=B∂H₂*(B^{T}w)−c as well.

$$\begin{matrix}[ Math . 32 ] & \\ {q}^{t + 1} = arg {min}_{q} ( {H}_{2} ( q ) + {J}_{{D}^{+}} ( Bq \vert \vert {\tilde{x}}^{t + 1} + c ) ) & ( 29 )\end{matrix}$$

$${\tilde{z}}^{t + 1} = \{ \begin{matrix}{\tilde{x}}^{t + 1} - 2 ( B {q}^{t + 1} - c ) \\ ( 1 - a ) {\tilde{z}}^{t} + α ( {\tilde{x}}^{t + 1} - 2 ( B {q}^{t + 1} - c ) )\end{matrix} \qquad ( 30 )$$

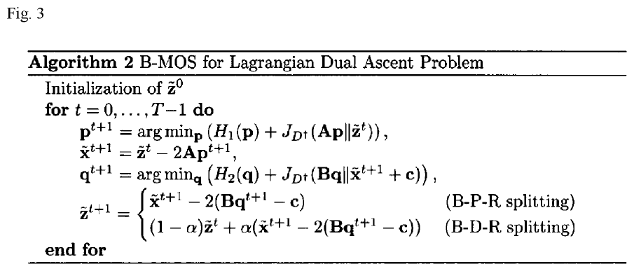

As has been described above, each of the B-P-R variable update rule and the B-D-R variable update rule for the Lagrange dual ascent problem is summarized as algorithm as illustrated in FIG. 3. FIG. 3 illustrates that the B-P-R variable update algorithm and the B-D-R variable update algorithm for the Lagrange dual ascent problem are implemented as update rules of the variables p and q and their dual variables ˜x and ˜z.

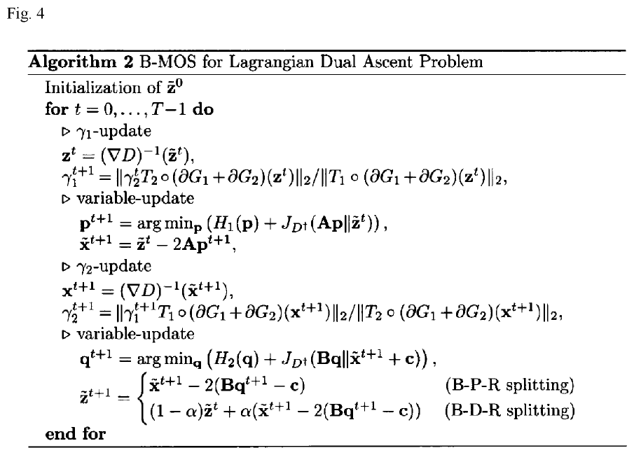

By adopting the design of ∇D of expression (23) into the two algorithms illustrated in FIG. 3, the B-P-R variable update algorithm and the B-D-R variable update algorithm illustrated in FIG. 4 are obtained.

6: Noise Elimination Problem of Image Using Total Variation Norm

Here, as an application example of the algorithm of FIG. 4, optimization algorithm for the noise elimination problem of an image using the total variation norm will be described.

In order to define the noise elimination problem of an image using the total variation norm, for example, cost functions H₁ and H₂ of the following expressions can be used.

H₁(p)=½∥p−s∥₂²

H₂(q)=μ( 74/2∥q∥₂²+∥q∥₁) [Math.33]

Here, p represents a variable representing an image, q is an auxiliary variable of p, and s represents an observation image (that is, an image before noise is eliminated). Further, μ and θ(>0) are predetermined coefficients.

It is assumed that two variables {p, q} are restrained by expression q=Φp (note that Φ is a square circulant matrix). Φ is a square circulant matrix, and thus an element qᵢ, which is the i-th element of q, can be obtained by discrete difference computation qᵢ=[Φp]ᵢ=pᵢ₋₁−pᵢ₊₁. Note that the reason for the use of the square circulant matrix Φ is for the purpose of reducing the amount of computation.

Here, by adopting A=Φ, B=−I, and c=0, it can be understood that the noise elimination problem on which the above assumption is made is described by expression (3). Thus, the algorithm of FIG. 4 can be used for the noise elimination problem.

The design of ∇D will be described below. For the first maximum monotone operator ∂G₁(z)=Φ∂H₁*(Φ^{T}_{Z}), for example, ∇D and (∇D)⁻¹ can be represented as shown in the following respective expressions.

$$\begin{matrix}[ Math . 34 ] & \\ ∇ D ( z ) = {γ}_{1}^{t + 1} {T}_{1} ( z ) = {γ}_{1}^{t + 1} ( {ΦΦ}^{T} + ξ I ) ( z ) & ( 31 )\end{matrix}$$

$${( ∇ D )}^{- 1} ( z ) = \frac{1}{{γ}_{1}^{t + 1}} {T}_{1}^{- 1} ( z ) = \frac{1}{{γ}_{1}^{t + 1}} {( {ΦΦ}^{T} + ξ I )}^{- 1} ( z ) \qquad ( 32 )$$

Here, ξ(>0) is a coefficient used such that a function T₁ satisfies strong monotonicity.

For the second maximum monotone operator ∂G₂(x)=−∂H₂*(−x)−c, for example, ∇D and (∇D)⁻¹ can be represented as shown in the following respective expressions.

$$\begin{matrix}[ Math . 35 ] & \\ ∇ D ( {x}_{i} ) = {γ}_{2}^{t + 1} {T}_{2} ( {x}_{i} ) = \{ \begin{matrix}\frac{{γ}_{2}^{t + 1}}{μ θ} {x}_{i} + \frac{1}{θ} ( {x}_{i} < \frac{μ v}{{γ}_{2}^{t + 1} ( v - μθ} ) \\ \frac{{γ}_{2}^{t + 1}}{v} {x}_{i} ( - \frac{μ v}{{γ}_{2}^{t + 1} ( v - μ θ )} \leq {x}_{i} < \frac{μ v}{{γ}_{2}^{t + 1} ( v - μθ} ) \\ \frac{{γ}_{2}^{t + 1}}{μ θ} {x}_{i} - \frac{1}{θ} ( \frac{μ v}{{γ}_{2}^{t + 1} ( v - μ θ )} \leq {x}_{i} )\end{matrix} & ( 33 )\end{matrix}$$

$${( ∇ D )}^{- 1} ( {x}_{i} ) = \frac{1}{{γ}_{2}^{t + 1}} {T}_{2}^{- 1} ( {x}_{i} ) = \{ \begin{matrix}\frac{μ θ}{{γ}_{2}^{t + 1}} {x}_{i} - \frac{μ}{{γ}_{2}^{t + 1}} ( {x}_{i} < - \frac{μ}{v - μ θ} ) \\ \frac{1}{{γ}_{2}^{t + 1}} {x}_{i} ( - \frac{μ}{v - μ θ} \leq {x}_{i} < \frac{μ}{v - μ θ} ) \\ \frac{μ θ}{{γ}_{2}^{r + 1}} {x}_{i} + \frac{μ}{{γ}_{2}^{r + 1}} ( \frac{μ}{v - μ θ} \leq {x}_{i} )\end{matrix} \qquad ( 34 )$$

Here, xᵢ (i=1, . . . , n) represents the i-th element of x. Further, v (>0) is a predetermined constant, and it is assumed that v >μθ holds.

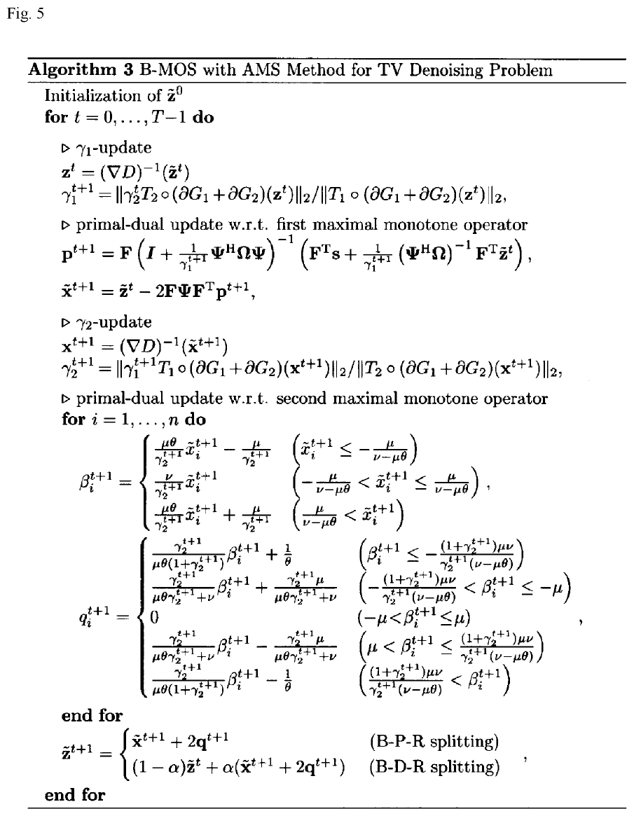

To summarize the above, the B-P-R variable update algorithm and the B-D-R variable update algorithm for the noise elimination problem on which the above assumption is made are as illustrated in FIG. 5. In FIG. 5, F and Ψ are an n-dimensional DFT matrix and a diagonal matrix that satisfy Φ=FΨF^{T}, respectively, and Ω is a diagonal matrix that satisfies (ΦΦ^{T}+ξI)=FΩF^{T}.

Here, ^{.H} represents a Hermitian transpose.

### First Embodiment

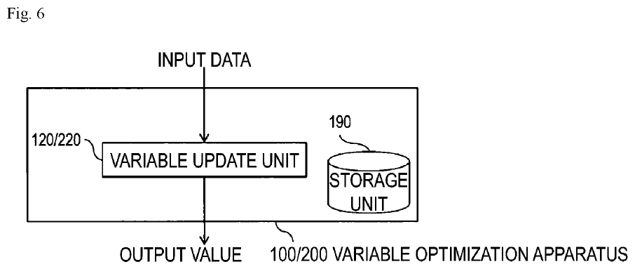

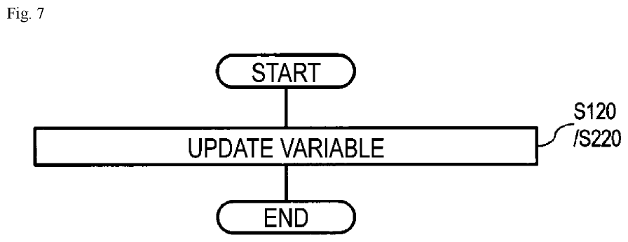

A variable optimization apparatus 100 will be described below with reference to FIGS. 6 and 7. FIG. 6 is a block diagram illustrating a configuration of the variable optimization apparatus 100. FIG. 7 is a flowchart illustrating operation of the variable optimization apparatus 100. As illustrated in FIG. 6, the variable optimization apparatus 100 includes a variable update unit 120 and a recording unit 190. The recording unit 190 is a configuration unit that records information necessary for processing of the variable optimization apparatus 100 as appropriate.

The variable optimization apparatus 100 optimizes a variable w ∈ Rⁿ (n is an integer of 1 or greater) being a target of optimization by using input data, and outputs the result of optimization as an output value. Here, the input data is data used for calculating a cost function G(w) that is used for optimization of the variable w. In the following description, it is assumed that the cost function G(w) for optimizing the variable w calculated by using the input data is represented by G(w)=G₁(w)+G₂(w) (note that the function Gᵢ(w): Rⁿ→R ∪{∞}(i=1, 2) is a closed proper convex function).

With reference to FIG. 7, the operation of the variable optimization apparatus 100 will be described.

In S120, the variable update unit 120 optimizes the variable w through a predetermined procedure by using input data, and outputs the result of optimization as an output value. This will be described in detail below. Note that it is assumed that the function D: Rⁿ→R used for definition of Bregman divergence is differentiable, and is a strictly convex function satisfying ∇D(0)=0.

First, the variable update unit 120 calculates setup data used at the time of optimizing the variable w by using the input data (S121-1). For example, the variable update unit 120 calculates the cost function Gᵢ(w)(i=1, 2), the D-resolvent operator Rᵢ(i=1, 2) defined by using the function D and the function Gᵢ, the D-Cayley operator Cᵢ(i=1, 2) defined by using the D-resolvent operator Rᵢ, and the strongly convex function ⁻Gᵢ(w)(i=1, 2) that approximates the function Gᵢ(w)(i=1, 2) as the setup data.

Next, the variable update unit 120 recursively calculates the value of the variable w by using the D-resolvent operator Rᵢ(i=1, 2) and the D-Cayley operator Cᵢ(i=1, 2) (S121-2). When the variable update unit 120 calculates ∇D(w), for the D-resolvent operator R₁ and the D-Cayley operator C₁, T₁(w)=∇⁻G₁(w)−∇⁻G₁(0) is used for calculation of ∇D(w), and for the D-resolvent operator R₂ and the D-Cayley operator C₂, T₂(w)=∇⁻G₂(w)−∇⁻G₂(0) is used for calculation of ∇D(w) (see expression (23)).

The variable update unit 120 can also be configured as a configuration unit that recursively calculates the value of the variable w, based on the algorithm of FIG. 2. In other words, in S120, the variable update unit 120 uses the input data to calculate predetermined setup data, and then repeats the calculation of w^{t+1}, which is the (t+1)-th update result of the variable w. Here, t is a variable (hereinafter also referred to as a counter) used for counting the number of times of update, and has an integer value of 0 or greater.

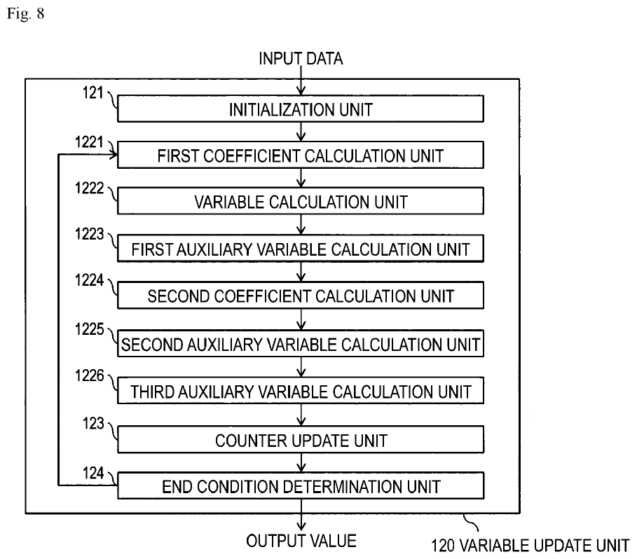

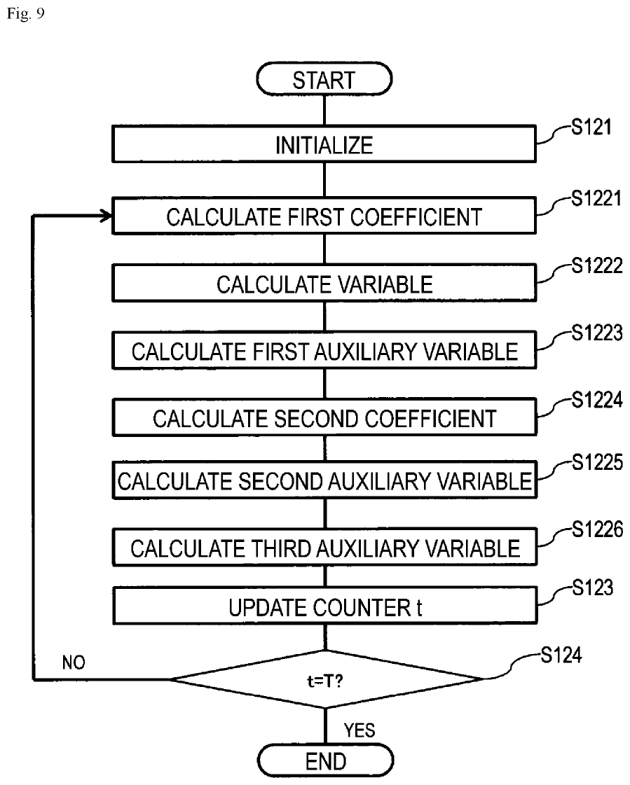

The variable update unit 120 will be described below with reference to FIGS. 8 and 9. FIG. 8 is a block diagram illustrating a configuration of the variable update unit 120. FIG. 9 is a flowchart illustrating operation of the variable update unit 120. As illustrated in FIG. 8, the variable update unit 120 includes an initialization unit 121, a first coefficient variable calculation unit 1221, a variable calculation unit 1222, a first auxiliary variable calculation unit 1223, a second coefficient variable calculation unit 1224, a second auxiliary variable calculation unit 1225, a third auxiliary variable calculation unit 1226, a counter update unit 123, and an end condition determination unit 124.

With reference to FIG. 9, the operation of the variable update unit 120 will be described. Note that, in the same manner as described above, let D: Rⁿ→R represent a strictly convex function (note that the function D is differentiable, and satisfies ∇D(0)=0), J_{D} represent Bregman divergence defined by using the function D, ⁻Gᵢ(w) (i=1, 2) represent a strongly convex function that approximates the function Gᵢ(w)(i=1, 2), and T₁(w) and T₂(w) represent functions defined by the following expressions.

T₁(w)=∇G̅₁(w)−∇G̅₁(0)

T₂(w)=∇G̅₂(w)−∇G̅₂(0) [Math.36]

Here, the auxiliary variables x, y, and z ∈ Rⁿ of the variable w are used.

In S121, the initialization unit 121 initializes the counter t. Specifically, t is set to 0. The initialization unit 121 calculates the setup data.

In S1221, the first coefficient calculation unit 1221 calculates γ₁^{t+1} which is the (t+1)-th update result of the first coefficient γ₁, by using the following expression.

γ₁^{t+1}=∥γ₂^{t}T₂∘(∂G₁+∂G₂)(z^{t})∥₂/∥T₁∘(∂G₁+∂G₂)(z^{t})∥₂ [Math.37]

In S1222, the variable calculation unit 1222 calculates w^{t+1}, which is the (t+1)-th update result of the variable w, by using the following expression.

$$\begin{matrix}[ Math . 38 ] & \\ {w}^{t + 1} = arg {min}_{w} ( {G}_{1} ( w ) + {J}_{D} ( w \vert \vert {z}^{t} ) ) & \end{matrix}$$

In S1223, the first auxiliary variable calculation unit 1223 calculates x^{t+1}, which is the (t+1)-th update result of the auxiliary variable x, by using the following expression.

x^{t+1}=2w^{t+1}−z^{t} [Math.39]

In S1224, the second coefficient calculation unit 1224 calculates γ₂^{t+1}, which is the (t+1)-th update result of the second coefficient γ₂, by using the following expression.

γ₂^{t+1}=∥γ₁^{t+1}T₁∘(∂G₁+∂G₂)(x^{t+1})∥₂/∥T₂∘(∂G₁+∂G₂)(x^{t+1})∥₂ [Math.40]

In S1225, the second auxiliary variable calculation unit 1225 calculates y^{t+1}, which is the (t+1)-th update result of the auxiliary variable y, by using the following expression.

$$\begin{matrix}[ Math . 41 ] & \\ {y}^{t + 1} = arg {min}_{y} ( {G}_{2} ( y ) + {J}_{D} ( y \vert \vert {x}^{t + 1} ) ) & \end{matrix}$$

In S1226, the third auxiliary variable calculation unit 1226 calculates z^{t+1}, which is the (t+1)-th update result of the auxiliary variable z, by using a predetermined expression.

When B-P-R monotone operator splitting is used, the following expression is used.

z^{t+1}₌₂y^{t+1}−x^{t+1} [Math.42]

When B-D-R monotone operator splitting is used, the following expression is used.

z^{t+1}=(1−α)z^{t}+α(2y^{t+1}+x^{t+1}) [Math.43]

(Note that, α is a real number satisfying 0<α<1)

In S123, the counter update unit 123 increments the counter t by 1. Specifically, the increment is performed as follows: t <- t+1.

In S124, if the counter t reaches a predetermined number T of times of update (T is an integer of 1 or greater) (that is, if t reaches T, and an end condition is satisfied), the end condition determination unit 124 uses a value w^{T} of the variable w at the time as an output value, and ends the processing. Otherwise, the processing returns to S1221. In other words, the variable update unit 120 repeats the calculation of S1221 to S124.

According to the invention of the present embodiment, variables being an optimization target can be optimized at high speed.

### Second Embodiment

A variable optimization apparatus 200 will be described below with reference to FIGS. 6 and 7. FIG. 6 is a block diagram illustrating a configuration of the variable optimization apparatus 200. FIG. 7 is a flowchart illustrating operation of the variable optimization apparatus 200. As illustrated in FIG. 6, the variable optimization apparatus 200 includes a variable update unit 220 and a recording unit 190. The recording unit 190 is a configuration unit that records information necessary for processing of the variable optimization apparatus 200 as appropriate.

The variable optimization apparatus 200 optimizes variables p ∈ R^{k} and q ∈ R^{m} (k and m are each an integer of 1 or greater) being a target of optimization by using input data, and outputs the result of optimization as an output value. Here, the input data is data used for calculating a cost function H₁(p)+H₂(q) for optimizing the variables p and q. In the following description, it is assumed that each of functions H₁(p): R^{k}→R∪{∞} and H₂(q): R^{M}→R∪{∞} constituting the cost function H₁(p)+H₂(q) for optimizing the variables p and q calculated by using the input data is a closed proper convex function. It is assumed that restraint is imposed with a constraint Ap+Bq=c that the variables p and q ought to satisfy, by using matrices A E R^{n×k} and B ∈ R^{n×m} and a vector c ∈ Rⁿ given in advance.

With reference to FIG. 7, the operation of the variable optimization apparatus 200 will be described.

In S220, the variable update unit 220 optimizes the variables p and q through a predetermined procedure by using input data, and outputs the result of optimization as an output value. The following will describe the variable update unit 220 configured as a configuration unit that recursively calculates the values of the variables p and q, based on the algorithm of FIG. 4. In other words, in S220, the variable update unit 220 uses the input data to calculate predetermined setup data, and then repeats the calculation of p^{t+1}, which is the (t+1)-th update result of the variable p, and q^{t+1}, which is the (t+1)-th update result of variable q. Here, t is a variable (hereinafter also referred to as a counter) used for counting the number of times of update, and has an integer value of 0 or greater.

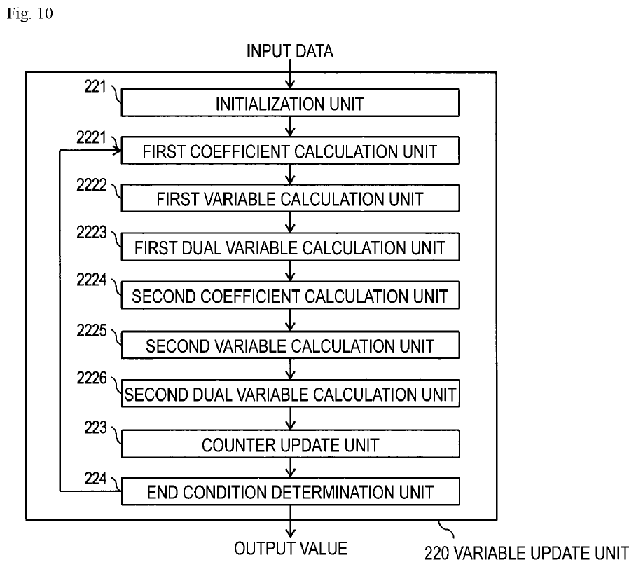

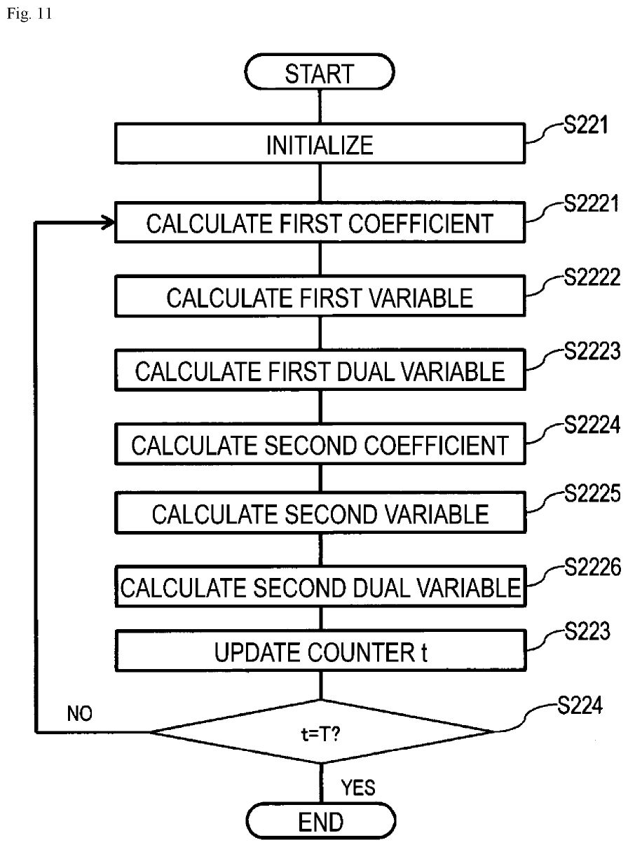

The variable update unit 220 will be described below with reference to FIGS. 10 and 11. FIG. 10 is a block diagram illustrating a configuration of the variable update unit 220. FIG. 11 is a flowchart illustrating operation of the variable update unit 220. As illustrated in FIG. 10, the variable update unit 220 includes an initialization unit 221, a first coefficient variable calculation unit 2221, a first variable calculation unit 2222, a first dual variable calculation unit 2223, a second coefficient variable calculation unit 2224, a second variable calculation unit 2225, a second dual variable calculation unit 2226, a counter update unit 223, and an end condition determination unit 224.

With reference to FIG. 11, the operation of the variable update unit 220 will be described. Note that let D: Rⁿ→R represent a strictly convex function (note that the function D is differentiable, and satisfies ∇D(0)=0), D⁺ represent a strongly convex function that satisfies ∇D⁺=(∇D)⁻¹, J_{D+} represent Bregman divergence defined by using the function D⁺, ∂G₁(w) and ∂G₂(w) (w ∈ Rⁿ is a dual variable) represent maximum monotone operators defined by the following expressions,

∂G₁(w)=A∂H₁^{*}(A^{T}w)

∂G₂(w)=B∂H₂^{*}(B^{T}w)−c[Math.44]

and T₁(w) and T₂(w) represent functions defined by the following expressions.

T₁(w)=∂G₁(w)

T₂(w)=∂G₂(w) [Math.45]

Here, for dual variables x and z ∈ Rⁿ, dual variables ˜x and ˜z ∈ Rⁿ defined by ˜x=∇D(x) and ˜z=∇D(z) are used.

In S221, the initialization unit 221 initializes the counter t. Specifically, t is set to 0. The initialization unit 221 calculates setup data used at the time of optimizing the variables p and q. For example, the initialization unit 221 calculates the cost functions H₁(p) and H₂(q) as the setup data.

In S2221, the first coefficient calculation unit 2221 calculates γ₁^{t+1}, which is the (t+1)-th update result of the first coefficient γ₁.

z^{t}=(∇D)⁻¹(\tilde{z}^{t})

γ₁^{t+1}=∥γ₂^{t}T₂∘(∂G₁+∂G₂)(z^{t})∥₂/∥T₁∘(∂G₁+∂G₂)(z^{t})∥₂ [Math.46]

In S2222, the first variable calculation unit 2222 calculates p^{t+1}, which is the (t+1)-th update result of the variable p, by using the following expression.

$$\begin{matrix}[ Math . 47 ] & \\ {p}^{t + 1} = arg {min}_{p} ( {H}_{1} ( p ) + {J}_{{D}^{+}} ( Ap \vert \vert {\tilde{z}}^{t} ) ) & \end{matrix}$$

In S2223, the first dual variable calculation unit 2223 calculates ˜x^{t+1}, which is the (t+1)-th update result of the dual variable ˜x, by using the following expression.

\tilde{x}^{t+1}=\tilde{z}^{t}−2Ap^{t+1} [Math.48]

In S2224, the second coefficient calculation unit 2224 calculates γ₂^{t+1}, which is the (t+1)-th update result of the second coefficient γ₂, by using the following expression.

x^{t+1}=(∇D)⁻¹(\tilde{x}^{t+1})

γ₂^{t+1}=∥γ₁^{t+1}T₁∘(∂G₁+∂G₂)(x^{t+1})∥₂/∥T₂∘(∂G₁+∂G₂)(x^{t+1})∥₂ [Math.49]

In S2225, the second variable calculation unit 2225 calculates q^{t+1}, which is the (t+1)-th update result of the variable q, by using the following expression.

$$\begin{matrix}[ Math . 50 ] & \\ {q}^{t + 1} = arg {min}_{q} ( {H}_{2} ( q ) + {J}_{{D}^{+}} ( Bq \vert \vert {\tilde{x}}^{t + 1} + c ) ) & \end{matrix}$$

In S2226, the second dual variable calculation unit 2226 calculates ˜z^{t+1}, which is the (t+1)-th update result of the dual variable ˜z, by using a predetermined expression.

When B-P-R monotone operator splitting is used, the following expression is used.

\tilde{z}^{t+1}=\tilde{x}^{t+1}−2(Bq^{t+1}−c) [Math.51]

When B-D-R monotone operator splitting is used, the following expression is used.

\tilde{z}^{t+1}=(1−α)\tilde{z}^{t}+α(\tilde{x}^{t+1}−2(Bq^{t+1}−c))[Math.52]

(Note that α is a real number satisfying 0<α<1) In S223, the counter update unit 223 increments the counter t by 1. Specifically, the increment is performed as follows: t<- t+1.

In S224, if the counter t reaches a predetermined number T of times of update (T is an integer of 1 or greater) (that is, if t reaches T, and an end condition is satisfied), the end condition determination unit 224 uses values p^{T} and q^{T} of the variables p and q at the time as output values, and ends the processing. Otherwise, the processing returns to S2221. In other words, the variable update unit 220 repeats the calculation of S2221 to S224.

According to the invention of the present embodiment, variables being an optimization target can be optimized at high speed.

### Third Embodiment

Here, an embodiment corresponding to the algorithm of FIG. 5 described in “6: Noise Elimination Problem of Image Using Total Variation Norm” of “Technical Background” will be described.

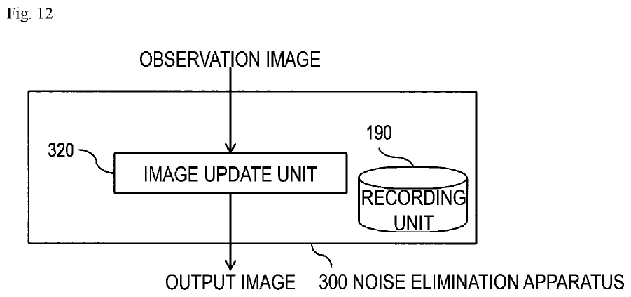

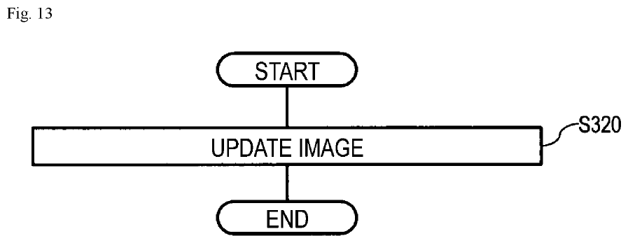

A noise elimination apparatus 300 will be described below with reference to FIGS. 12 and 13. FIG. 12 is a block diagram illustrating a configuration of the noise elimination apparatus 300. FIG. 13 is a flowchart illustrating operation of the noise elimination apparatus 300. As illustrated in FIG. 12, the noise elimination apparatus 300 includes an image update unit 320 and a recording unit 190. The recording unit 190 is a configuration unit that records information necessary for processing of the noise elimination apparatus 300 as appropriate.

The noise elimination apparatus 300 uses an observation image s to generate an output image, from which noise is eliminated, and outputs the output image. In this case, the variable(s) p (and q) are optimized by using the variable p ∈ R^{k} representing the image and the auxiliary variable q ∈ R^{m} of the variable p (k and m are each an integer of 1 or greater), and the output image is thereby generated. Here, as the functions H₁(p) and H₂(q) constituting the cost function H₁(p)+H₂(q) for optimizing the variables p and q, the functions defined in the following expressions are used.

$$\begin{matrix}[ Math . 53 ] & \\ {H}_{1} ( p ) = \frac{1}{2} {‖ p - s ‖}_{2}^{2} {H}_{2} ( q ) = μ ( \frac{θ}{2} {‖ q ‖}_{2}^{2} + {‖ q ‖}_{1} ) & \end{matrix}$$

Here, μ and θ(>0) are predetermined coefficients.

It is assumed that the variables {p, q} are restrained by expression q=Φp (note that Φ is a square circulant matrix given in advance).

With reference to FIG. 13, the operation of the noise elimination apparatus 300 will be described.

In S320, the image update unit 320 uses an observation image s to optimize the variables p and q through a predetermined procedure, and outputs the result of optimization as an output image. The following will describe the image update unit 320 configured as a configuration unit that recursively calculates the values of the variables p and q, based on the algorithm of FIG. 5. In other words, in S320, the image update unit 320 uses the observation image s to calculate predetermined setup data, and then repeats the calculation of p^{t+1}, which is the (t+1)-th update result of the variable p, and q^{t+1}, which is the (t+1)-th update result of variable q. Here, t is a variable (hereinafter also referred to as a counter) used for counting the number of times of update, and has an integer value of 0 or greater.

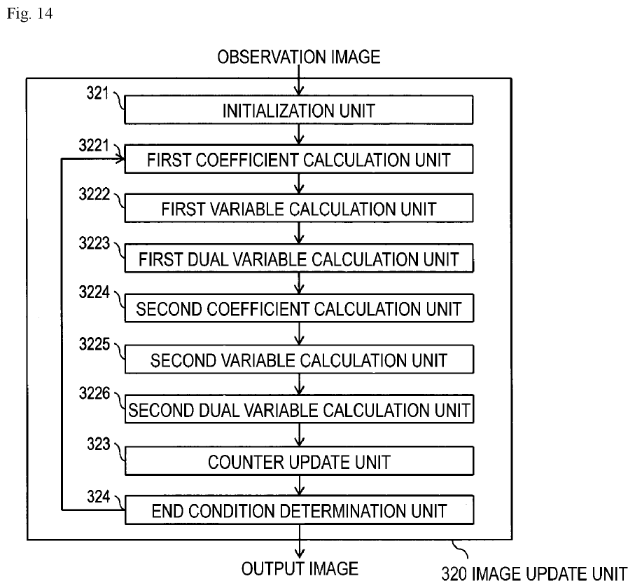

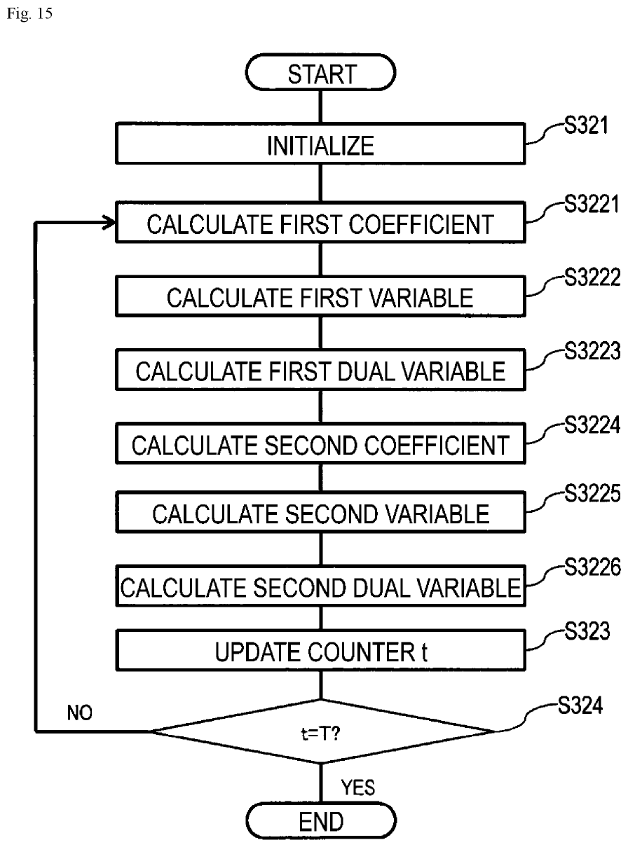

The image update unit 320 will be described below with reference to FIGS. 14 and 15.

FIG. 14 is a block diagram illustrating a configuration of the image update unit 320. FIG. 15 is a flowchart illustrating operation of the image update unit 320. As illustrated in FIG. 14, the image update unit 320 includes an initialization unit 321, a first coefficient variable calculation unit 3221, a first variable calculation unit 3222, a first dual variable calculation unit 3223, a second coefficient variable calculation unit 3224, a second variable calculation unit 3225, a second dual variable calculation unit 3226, a counter update unit 323, and an end condition determination unit 324.

With reference to FIG. 15, the operation of the image update unit 320 will be described. Note that let D: Rⁿ→R represent a strictly convex function (note that the function D is differentiable, and satisfies ∇D(0)=0), D⁺ represent a strongly convex function that satisfies ∇D⁺=(∇D)⁻¹, ∂G₁(w) and ∂G₂(w) (w ∈ Rⁿ is a dual variable) represent maximum monotone operators defined by the following expressions,

∂G₁(w)=Φ∂H₁^{*}(Φ^{T}w)

∂G₂(w)=−∂H₂^{*}(−w) [Math.54]

and T₁(w) and T₂(w) represent functions defined by the following expressions.

$$\begin{matrix}[ Math . 55 ] & \\ {T}_{1} ( z ) = ( Φ {Φ}^{T} + ξ I ) ( z ) {T}_{2} ( x ) = \{ \begin{matrix}\frac{1}{μ θ} {x}_{i} + \frac{1}{θ {γ}_{2}^{t + 1}} ( {x}_{i} < - \frac{μ v}{{γ}_{2}^{t + 1} ( v - μ θ )} ) \\ \frac{1}{v} {x}_{i} ( - \frac{μ v}{{γ}_{2}^{t + 1} ( v - μ θ )} \leq {x}_{i} < \frac{μ v}{{γ}_{2}^{t + 1} ( v - μ θ )} ) \\ \frac{1}{μ θ} {x}_{i} - \frac{1}{{θγ}_{2}^{t + 1}} ( \frac{μ v}{{γ}_{2}^{t + 1} ( v - μ θ )} \leq {x}_{i} )\end{matrix} & \end{matrix}$$

(Note that xᵢ (i=1, . . . , n) represents the i-th element of x. Further, v (>0) is a predetermined constant, and it is assumed that v >μθ holds.) Here, for dual variables x and z ∈ Rⁿ, dual variables ˜x and ˜z ∈ Rⁿ defined by ˜x=∇D(x) and ˜z=∇D(z) are used.

F represents an n-dimensional DFT matrix and Ψ a diagonal matrix that satisfy Φ=FΨF^{T}, and Ω represents a diagonal matrix that satisfies (ΦΦ^{T}+ξI)=FΨF^{T}.

In S321, the initialization unit 321 initializes the counter t. Specifically, t is set to 0. The initialization unit 321 calculates setup data used at the time of optimizing the variables p and q. For example, the initialization unit 321 calculates the cost functions H₁(p) and H₂(q) as the setup data.

In S3221, the first coefficient calculation unit 3221 calculates γ₁^{t+1}, which is the (t+1)-th update result of the first coefficient γ₁.

z^{t}=(∇D)⁻¹(\tilde{z}^{t})

γ₁^{t+1}=∥γ₂^{t}T₂∘(∂G₁+∂G₂)(z^{t})∥₂/∥T₁∘(∂G₁+∂G₂)(z^{t})∥₂[ Math.56]

In S3222, the first variable calculation unit 3222 calculates p^{t+1}, which is the (t+1)-th update result of the variable p, by using the following expression.

$$\begin{matrix}[ Math . 57 ] & \\ {p}^{t + 1} = {F ( I + \frac{1}{{γ}_{1}^{t + 1}} {Ψ}^{H} Ω Ψ )}^{- 1} ( {F}^{T} s + \frac{1}{{γ}_{1}^{t + 1}} {( {Ψ}^{H} Ω )}^{- 1} {F}^{T} {\tilde{z}}^{t} ) & \end{matrix}$$

In S3223, the first dual variable calculation unit 3223 calculates ˜x^{t+1}, which is the (t+1)-th update result of the dual variable ˜x, by using the following expression.

\tilde{x}^{t+1}=\tilde{z}^{t}−2FΨF^{T}p^{t+1} [Math.58]

In S3224, the second coefficient calculation unit 3224 calculates γ₂^{t+1}, which is the (t+1)-th update result of the second coefficient γ₂, by using the following expression.

x^{t+1}=(∇D)⁻¹(\tilde{x}^{t+1})

γ₂^{t+1}=∥γ₁^{t+1}T₁∘(∂G₁+∂G₂)(x^{t+1})∥₂/∥T₂∘(∂G₁+∂G₂)(x^{t+1})∥₂ [Math.59]

In S3225, the second variable calculation unit 3225 calculates q^{t+1}, which is the (t+1)-th update result of the variable q, by using the following expression.

$$\begin{matrix}[ Math . 60 ] & \\ {β}_{i}^{t + 1} = \{ \begin{matrix}\frac{μ θ}{{γ}_{2}^{t + 1}} {\tilde{x}}_{i}^{t + 1} - \frac{μ}{{γ}_{2}^{t + 1}} & ( {\tilde{x}}_{i}^{t + 1} \leq - \frac{μ}{v - μ θ} ) \\ \frac{v}{{γ}_{2}^{t + 1}} {\tilde{x}}_{i}^{t + 1} & ( - \frac{μ}{v - μ θ} < {\tilde{x}}_{i}^{t + 1} \leq \frac{μ}{v - μ θ} ) \\ \frac{μ θ}{{γ}_{2}^{t + 1}} {\tilde{x}}_{i}^{t + 1} + \frac{μ}{{γ}_{2}^{t + 1}} & ( \frac{μ}{v - μ θ} < {\tilde{x}}_{i}^{t + 1} )\end{matrix} ( i = 1 , … , n ) {q}_{i}^{t + 1} = \{ \begin{matrix}\frac{{γ}_{2}^{t + 1}}{μ θ ( 1 + {γ}_{2}^{t + 1} )} {β}_{i}^{t + 1} + \frac{1}{θ} & ( {β}_{i}^{t + 1} \leq - \frac{( 1 + {γ}_{2}^{t + 1} ) μ v}{{γ}_{2}^{t + 1} ( v - μ θ )} ) \\ \frac{{γ}_{2}^{t + 1}}{{μθγ}_{2}^{t + 1} + v} {β}_{i}^{t + 1} + \frac{{γ}_{2}^{t + 1} μ}{{μθγ}_{2}^{t + 1} + v} & ( - \frac{( 1 + {γ}_{2}^{t + 1} ) μ v}{{γ}_{2}^{t + 1} ( v - μ θ )} < {β}_{i}^{t + 1} \leq - μ ) \\ 0 & ( - μ < {β}_{i}^{t + 1} \leq μ ) \\ \frac{{γ}_{2}^{t + 1}}{{μθγ}_{2}^{t + 1} + v} {β}_{i}^{t + 1} - \frac{{γ}_{2}^{t + 1} μ}{{μθγ}_{2}^{t + 1} + v} & ( μ < {β}_{i}^{t + 1} \leq \frac{( 1 + {γ}_{2}^{t + 1} ) μ v}{{γ}_{2}^{t + 1} ( v - μ θ )} ) \\ \frac{{γ}_{2}^{t + 1}}{μ θ ( 1 + {γ}_{2}^{t + 1} )} {β}_{i}^{t + 1} - \frac{1}{θ} & ( \frac{( 1 + {γ}_{2}^{t + 1} ) μ v}{{γ}_{2}^{t + 1} ( v - μ θ )} < {β}_{i}^{t + 1} )\end{matrix} ( i = 1 , … , n ) \\ {q}^{t + 1} = {[ {q}_{1}^{t + 1} , … , {q}_{n}^{t + 1} ]}^{T} & \end{matrix}$$

Note that ˜x^{t+1}=[˜x₁ ^{t+1}, . . . ,˜xₙ^{t+1}]^{T}.

In S3226, the second dual variable calculation unit 3226 calculates ˜z^{t+1}, which is the (t+1)-th update result of the dual variable ˜z, by using a predetermined expression.

When B-P-R monotone operator splitting is used, the following expression is used.

\tilde{z}^{t+1}=\tilde{x}^{t+1}+2q^{t+1} [Math.61]

When B-D-R monotone operator splitting is used, the following expression is used.

\tilde{z}^{t+1}=(1−α)\tilde{z}^{t}+α(\tilde{x}^{t+1}+2q^{t+1}) [Math.62]

(Note that, α is a real number satisfying 0<α<1) In S323, the counter update unit 323 increments the counter t by 1. Specifically, the increment is performed as follows: t<- t+1.

In S324, if the counter t reaches a predetermined number T of times of update (T is an integer of 1 or greater) (that is, if t reaches T, and an end condition is satisfied), the end condition determination unit 324 uses a value p^{T} of the variable p at the time as an output image, and ends the processing. Otherwise, the processing returns to S3221. In other words, the image update unit 320 repeats the calculation of S3221 to S324.

According to the invention of the present embodiment, an image obtained by eliminating noise from an observation image can be generated at high speed.

Supplement

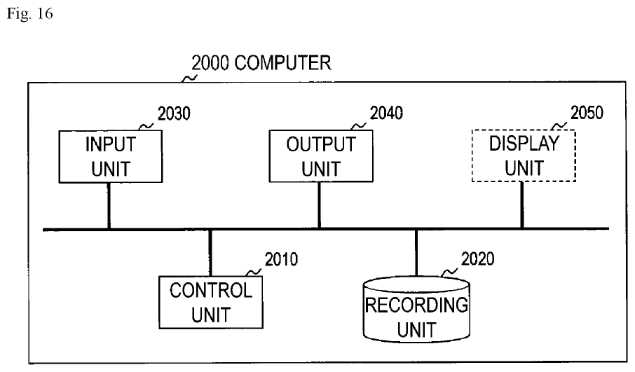

FIG. 16 is a diagram illustrating an example of a functional configuration of a computer implementing each apparatus described above. The processing in each of the above-described apparatuses can be performed by causing a recording unit 2020 to read a program for causing a computer to function as each of the above-described apparatuses, and operating the program in a control unit 2010, an input unit 2030, an output unit 2040, and the like.

The apparatus according to the present invention includes, for example, as single hardware entities, an input unit to which a keyboard or the like can be connected, an output unit to which a liquid crystal display or the like can be connected, a communication unit to which a communication apparatus (for example, a communication cable) capable of communication with the outside of the hardware entity can be connected, a Central Processing Unit (CPU, which may include a cache memory, a register, and the like), a RAM or a ROM that is a memory, an external storage apparatus that is a hard disk, and a bus connected for data exchange with the input unit, the output unit, the communication unit, the CPU, the RAM, the ROM, and the external storage apparatuses. An apparatus (drive) capable of reading and writing from and to a recording medium such as a CD-ROM may be provided in the hardware entity as necessary. An example of a physical entity including such hardware resources is a general-purpose computer.

A program necessary to implement the above-described functions, data necessary for processing of this program, and the like are stored in the external storage apparatus of the hardware entity (the present invention is not limited to the external storage apparatus; for example, the program may be read out and stored in a ROM that is a dedicated storage apparatus). For example, data obtained by the processing of the program is appropriately stored in a RAM, the external storage apparatus, or the like.

In the hardware entity, each program and data necessary for the processing of each program stored in the external storage apparatus (or a ROM, for example) are read into a memory as necessary and appropriately interpreted, executed, or processed by a CPU. As a result, the CPU implements a predetermined function (each of components represented by xxx unit, xxx means, or the like).

The present invention is not limited to the above-described embodiment, and appropriate changes can be made without departing from the spirit of the present invention. The processing described in the embodiments are not only executed in time series in the described order, but also may be executed in parallel or individually according to a processing capability of an apparatus that executes the processing or as necessary.

As described above, when a processing function in the hardware entity (the apparatus of the present invention) described in the embodiment is implemented by a computer, processing content of a function that the hardware entity should have is described by a program. By executing this program using the computer, the processing function in the hardware entity is implemented on the computer.

The program in which the processing details are described can be recorded on a computer-readable recording medium. The computer-readable recording medium, for example, may be any type of medium such as a magnetic recording apparatus, an optical disc, a magneto-optical recording medium, or a semiconductor memory. Specifically, for example, a hard disk apparatus, a flexible disk, a magnetic tape, or the like can be used as a magnetic recording apparatus, a Digital Versatile Disc (DVD), a DVD-Random Access Memory (RAM), a Compact Disc Read Only Memory (CD-ROM), CD-R (Recordable)/RW (ReWritable), or the like can be used as an optical disc, a Magneto-Optical disc (MO) or the like can be used as a magneto-optical recording medium, and an Electronically Erasable and Programmable-Read Only Memory (EEP-ROM) or the like can be used as a semiconductor memory.

In addition, the program is distributed, for example, by selling, transferring, or lending a portable recording medium such as a DVD or a CD-ROM with the program recorded on it. Further, the program may be stored in a storage apparatus of a server computer and transmitted from the server computer to another computer via a network so that the program is distributed.

For example, a computer executing the program first temporarily stores the program recorded on the portable recording medium or the program transmitted from the server computer in its own storage apparatus. When executing the processing, the computer reads the program stored in its own storage apparatus and executes the processing in accordance with the read program. Further, as another execution mode of this program, the computer may directly read the program from the portable recording medium and execute processing in accordance with the program, or, further, may sequentially execute the processing in accordance with the received program each time the program is transferred from the server computer to the computer. In addition, another configuration to execute the processing through a so-called application service provider (ASP) service in which processing functions are implemented just by issuing an instruction to execute the program and obtaining results without transmitting the program from the server computer to the computer may be employed. Further, the program in this mode is assumed to include information which is provided for processing of a computer and is equivalent to a program (data or the like that has characteristics of regulating processing of the computer rather than being a direct instruction to the computer).

Although the hardware entity is configured by a predetermined program being executed on the computer in the present embodiment, at least a part of the processing content of the hardware entity may be implemented in hardware.

The foregoing description of the embodiments of the present invention has been presented for purposes of illustration and description. The foregoing description does not intend to be exhaustive and does not intend to limit the invention to the precise forms disclosed.

Modifications and variations are possible from the teachings above. The embodiments have been chosen and expressed in order to provide the best demonstration of the principles of the present invention, and to enable those skilled in the art to utilize the present invention in numerous embodiments and with addition of various modifications suitable for actual use considered. All such modifications and variations are within the scope of the present invention defined by the appended claims that are interpreted according to the width provided justly lawfully and fairly.

1. A variable optimization apparatus comprising:
a processor; and
a memory storing instructions configured to execute a method comprising:
by assuming that:
w ∈ Rⁿ is a variable being an optimization target, and G(w)(=G₁(w)+G₂(w)) is a cost function for optimizing the variable w, calculated by using input data (note that a function Gᵢ(w): Rⁿ→R∪{∞} (i=1, 2) is a closed proper convex function), and
D: Rⁿ→R is a strictly convex function (note that the function D is differentiable, and satisfies ∇D(0)=0), and Rᵢ(i=1, 2) and Cᵢ (i=1, 2) are a D-resolvent operator and a D-Cayley operator defined by following expressions, respectively,
Rᵢ=(I+(∇D)⁻¹∘∂Gᵢ)⁻¹
Cᵢ=(I+(∇D)⁻¹∘∂Gᵢ)⁻¹∘(I−(∇D)⁻¹∘∂Gᵢ) [Math.63]
recursively determining a value of the variable w by using the D-resolvent operator Rᵢ(i=1, 2) and the D-Cayley operator Cᵢ(i=1, 2),
wherein ⁻G(w) (i=1, 2) is a strongly convex function approximating the function Gᵢ(w)(i=1, 2), and
wherein the calculating ∇D(w), for a D-resolvent operator R₁ and a D-Cayley operator C₁, T₁(w)=∇⁻G₁(w)−∇⁻G₁(0) is used for calculation of ∇D(w), and for a D-resolvent operator R₂ and a D-Cayley operator C₂, uses T₂(w)=∇₋G₂(w)−∇⁻G₂(0).

2. A variable optimization apparatus comprising:
a processor; and
a memory storing instructions configured to execute a method comprising:
by assuming that
w ∈ Rⁿ is a variable being an optimization target, and G(w)(=G₁(w)+G₂(w)) is a cost function for optimizing the variable w, calculated by using input data (note that a function Gᵢ(w): Rⁿ→R∪{∞} (i=1, 2) is a closed proper convex function),
calculating w^{t+1} being (t+1)-th update result of the variable w,
wherein x, y, and z ∈ Rⁿ are each an auxiliary variable of the variable w, D: Rⁿ→R is a strictly convex function (note that the function D is differentiable, and satisfies ∇D(0)=0), J_{D} is Bregman divergence defined by using the function D, ⁻Gᵢ(w) (i=1, 2) is a strongly convex function approximating the function Gᵢ(w)(i=1, 2), and T₁(w) and T₂(w) are functions defined by following expressions, respectively,
T₁(w)=∇G̅₁(w)−∇G̅₁(0)
T₂(w)=∇G̅₂(w)−∇G̅₂(0)[Math.64]
calculating γ₁^{t+1} being (t+1)-th update result of a first coefficient γ₁ by using a following expression,
γ₁^{t+1}=∥γ₂^{t}T₂∘(∂G₁+∂G₂)(z^{t})∥₂/∥T₁∘(∂G₁+∂G₂)(z^{t})∥₂ [Math.65];
calculating w^{t+1} being (t+1)-th update result of the variable w by using a following expression,
$$\begin{matrix}[ Math . 66 ] & \\ {w}^{t + 1} = arg {min}_{w} ( {G}_{1} ( w ) + {J}_{D} ( w \vert \vert {z}^{t} ) ) ; & \end{matrix}$$
calculating x^{t+1} being (t+1)-th update result of the auxiliary variable x by using a following expression,
x^{t+1}=2w^{t+1}−z^{t} [Math.67];
calculating γ₂^{t+1} being (t+1)-th update result of a second coefficient γ₂ by using a following expression,
γ₂^{t+1}=∥γ₁^{t}T₂∘(∂G₁+∂G₂)(x^{t+1})∥₂/∥T₁∘(∂G₁+∂G₂)(x^{t+1})∥₂ [Math.68];
calculating y^{t+1} being (t+1)-th update result of the auxiliary variable y by using a following expression,
$$\begin{matrix}[ Math . 69 ] & \\ {y}^{t + 1} = arg {min}_{y} ( {G}_{2} ( y ) + {J}_{D} ( y \vert \vert {x}^{t + 1} ) ) [ [ , ] ] ; & \end{matrix}$$
calculating z^{t+1} being (t+1)-th update result of the auxiliary variable z by using a following expression.
z^{t+1}=2y^{t+1}−x^{t+1} [Math.70]

3. A variable optimization apparatus comprising:
a processor; and
a memory storing instructions configured to execute a method comprising:
by assuming that
w ∈ Rⁿ is a variable being an optimization target, and G(w)(=G₁(w)+G₂(w)) is a cost function for optimizing the variable w, calculated by using input data (note that a function Gᵢ(w): Rⁿ→R∪{∞} (i=1, 2) is a closed proper convex function), calculating w^{t+1} being (t+1)-th update result of the variable w,
wherein x, y, and z ∈ Rⁿ are each an auxiliary variable of the variable w, D: Rⁿ→R is a strictly convex function (the function D is differentiable, and satisfies ∇D(0)=0), J_{D} is Bregman divergence defined by using the function D, ⁻Gᵢ(w) (i=1, 2) is a strongly convex function approximating the function Gᵢ(w)(i=1, 2), and T₁(w) and T₂(w) are functions defined by following expressions, respectively,
T₁(w)=∇G̅₁(w)−∇G̅₁(0)
T₂(w)=∇G̅₂(w)−∇G̅₂(0)[Math.71]
calculating γ₁^{t+1} being (t+1)-th update result of a first coefficient γ₁ by using a following expression,
γ₁^{t+1}=∥γ₂^{t}T₂∘(∂G₁+∂G₂)(z^{t})∥₂/∥T₁∘(∂G₁+∂G₂)(z^{t})∥₂ [Math.72];
calculating w^{t+1} being (t+1)-th update result of the variable w by using a following expression,
$$\begin{matrix}[ Math . 73 ] & \\ {w}^{t + 1} = arg {min}_{w} ( {G}_{1} ( w ) + {J}_{D} ( w \vert \vert {z}^{t} ) ) ; & \end{matrix}$$
calculating x^{t+1} being (t+1)-th update result of the auxiliary variable x by using a following expression,
x^{t+1}-2w^{t+1}−z^{t}[Math.74];
calculating γ₂^{t+1} being (t+1)-th update result of a second coefficient γ₂ by using a following expression,
γ₂^{t+1}=∥γ₁^{t+1}T₁∘(∂G₁+∂G₂)(x^{t+1})∥₂/∥T₂∘(∂G₁+∂G₂)(x^{t+1})∥₂ [Math.75];
calculating y^{t+1} being (t+1)-th update result of the auxiliary variable y by using a following expression,
$$\begin{matrix}[ Math . 76 ] & \\ {y}^{t + 1} = arg {min}_{y} ( {G}_{2} ( y ) + {J}_{D} ( y \vert \vert {x}^{t + 1} ) ) [ [ , ] ] ; & \end{matrix}$$
calculating z^{t+1} being (t+1)-th update result of the auxiliary variable z by using a following expression,
z^{t+1}=(1−α)z^{t}+α(2y^{t+1}−x^{t+1})[Math.77]
(α is a real number satisfying 0<α<1).

4.-7. (canceled)

8. The variable optimization apparatus according to claim 1, the instructions further configured to execute a method comprising:
generating, based on the recursively determining the value of the variable w upon pixels of an input image for noise elimination, an output image without a noise.

9. The variable optimization apparatus according to claim 2, the instructions further configured to execute a method comprising:
generating, based on pixels of an input image for noise elimination at least using the cost function, an output image without a noise.

10. The variable optimization apparatus according to claim 3, the instructions further configured to execute a method comprising:
generating, based on pixels of an input image for noise elimination at least using the cost function, an output image without a noise.
